(19) United States
(12) Patent Application Publication
(10) Pub. No.: US 2004/0003509 A1
(43) Pub. Date: Jan. 8, 2004

(54) Stud spacer

(76) Inventor: Larry W. Peterson, Iowa City, IA (US)

Correspondence Address: STURM & FIX LLP, 101 WEST SECOND STREET, SUITE 304, DAVENPORT, IA, 52801, US

(21) Appl. No.: 10/189,293

(22) Filed: Jul. 2, 2002

(51) Int. Cl. G01D 21/00

(52) U.S. Cl. 33/645

(57) ABSTRACT

A stud spacer having a light frame with a row of stud-receiving spaced notches-with inverted U-shaped liners attached to forward and rearward walls. The frame is formed by two elongated sections of L-shape in cross section. Two legs of adjusting length support the frame. The liners have walls inclining outwardly at their lower ends.

### THE FIELD OF THIS INVENTION

This invention is in the field of studding spaces for assisting a carpenter by holding studs at desired spacing preparatory to nailing the studs to top and bottom plates of a wall section.

### BACKGROUND OF THE INVENTION

The patents issued in the stud spacing art each show an advance. For example, U.S. Pat. No. 2,567,586, issued to Werder, discloses a spacer with stud engaging lugs, which engages the end of the studs but not the tops thereof. Because the lugs project from the spacer frame, they receive less support. For this reason the lugs must be made of thick material such as thick steel thereby causing the tool to be expensive, heavy and unwieldy.

U.S. Pat. No. 5,274,973, issued to Liang, is drawn to a stud spacer used under the studs and hence does not disclose a reusable tool but an expensive permanent installation. The Currie invention of U.S. Pat. No. 3,169,320 is a layout template for making, only, and cannot physically hold stud-ends in place. The design taught by Diamontis in U.S. Pat. No. 4,625,415 must be dismantled.

The spacer of Dreiling 4,527,337 is useful, but cannot be used without a chisel. The chiseling process would be labor intensive and time consuming. The U.S. Pat. No. 4,843,726, teaches a tool, which is designed as a heavy tool. The patent to Hardin, U.S. Pat. No. 4,420,921, is useful but complex and costly. The prior art studding spacers have been useful but are not on the market today to my knowledge.

A special starting spacer with a large notch for a coroner stud, has long been needed. It would also need one or more single stud-notches to guide use of a later used longer spacer hereof, having many, many more notches.

### OBJECTIVES

An objective hereof is to provide a spacer that is hollow, light and easy to use. A hollow spacer could have the disadvantage of being: (a) too weak and bendable, or (b) or such heavy gauge metal as to be too heavy and too costly. But it is a purpose hereof, to overcome these disadvantages. He spacer hereof is strengthened by liners of inverted U-shape attached to the forward, and bottom walls of the frame. Each liner protects the light sheet metal edges of the frame at its notch.

The formation of the box-like frame could be done by extrusion, but then the later cutting-in of the notches would be costly and slow. The solution, herein, is to make the frame of two L-shaped sections, each of one piece. The L-shaped sections are then attached together by welding to form horizontal and vertical walls of an elongated box-like configuration. This way, the notches can be done earlier and can be easily cut into the two frame sections, while each section is still flat stock, and before each is bent into an L-shape. Thus a strong, long-lasting spacer if formed at the lowest possibly cost, and yet of light weight and easy to maneuver.

Adjustable legs under the new spacer support each spacer above a horizontal surface ready for placement of studs in the notches. The leg adjustability accommodates studs of varying dimensions.

Easy stud placement in notches is provided by having the walls of each notch spaced further at their lower ends. The inclined walls of the notches then glide the studs into place.

A handle at the center of balance makes for quick handling. A new special starting spacer is also provided herein, having a wide notch to receive a multiple-section, compound corner stud-group such a stud-group has two studs separated by spacers of stud thickness dimension. The new starting spacer also has one or more single-stud notches to guise use of a later-used, long spacer hereof. The starting spacer hereof can also be made longer, as disclosed herein, to serve as a single tool, rather than using two spacers.

It is to be understood that both the foregoing general description and the following detailed description and explanatory only are not restrictive of the invention as claimed.

The accompanying drawings constitute a part of the specification, and illustrate embodiments, and principles of this invention.

### BRIEF DESCRIPTION OF THE DRAWINGS

The numerous objects and advantages of the present invention may be better understood by those skilled in the art by following the drawings in which FIG. 1 is a frontal elevation of a starting spacer.

FIG. 2 is a bottom view of the starting spacer.

FIG. 3 is a top view of the starting spacer of FIG. 1.

FIG. 4 is a left end view of the spacer of FIG. 1.

Showing an end-closure wall. Another such closure wall is at the right end also.

FIG. 5 is a frontal elevation of a broken-away portion of a spacer modification having a notch liner.

The remainder of this FIG. 5 modification is not shown, but it would be the same as FIG. 1, except that each notch would be lined.

FIG. 6 is a sectional view, somewhat as through FIG. 5 at a line 6-6, but differing in that FIG. 6 shows a notch liner of the FIG. 5 type. FIG. 5A is a right end view of FIG. 1, except that the legs are not shown. The left end view is identical to the right end view.

FIG. 7 is a left end view of FIG. 1, but the left end wall is broken away in places and the legs are not shown.

FIG. 8 is a front view of a second used spacer modification.

FIG. 9 is a bottom view of FIG. 8.

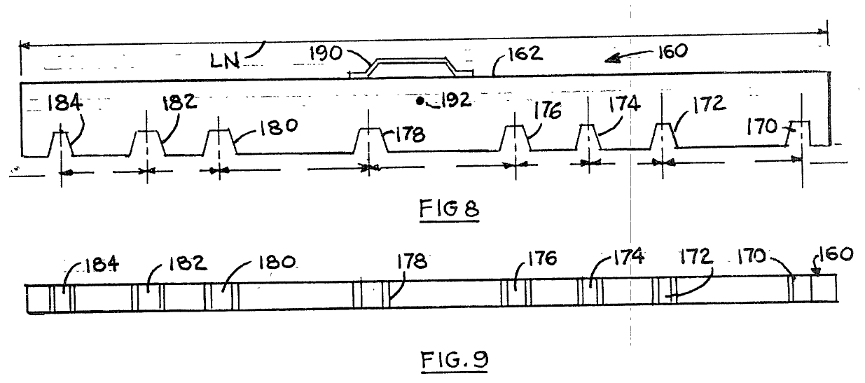

No liners are shown in FIGS. 8 and 9 as they are shown in FIG. 5 and 6, but would be used in the FIG. 8 way.

Notch liners are not shown in the notches of the spacer of FIG. 8 and 9, because they are already illustrated in FIGS. 5 and 6, but liners would be used in the spacer of FIG. 8 also. FIG. 9 is a bottom view of FIG. 8.

### DETAILED DESCRIPTION

In FIG. 1 is a starting spacer 10 and also a first used, first spacer 10, having an elongated frame 12, having a rearward surface 19, FIG. 3.

As seen in FIGS. 1 and 3, the frame 12 has a first notch 20 in the underside 21 thereof. The first notch 20 has a vertical, planar, right end starting surface 22 or first surface 22, extending directly rearwardly from a vertical, planar, forward surface 23 of the frame 12.

There is a first distance A, of 16 inches, from the top of the left end, upwardly extending, right wall 24 of the first notch 20, to the surface 22. The center of a second notch 27 is spaced from the upper end of the left wall 24 by a 16 inch second distance B.

Having the first and second notches 20 and 27, the starting first spacer is capable of starting at different times, wall section stud spacing of 16 inches, and 24 inches, for 2×4 studs, and 2×6 studs respectively. In FIG. 1, the first notch 20 has its left upwardly extending wall 24 inclining with respect to a vertical dotted line 25 in a manner causing the lower end of the first 20 notch to be wider, left to right, for the easy entry of the studs not shown.

The frame 12 has a third notch 28, having upright, right and left, walls 29, which are preferably inclined with respect to the vertical, so as to cause the lower ends of the sides of the notch 27 to be more widely spaced than there above. This provides easier entry and exit of studs.

The same wall inching is also used on the walls of the third notch 28. In FIGS. 1 and 7 the frame 12 is horizontally elongated having front and rear frame sections 46 and 48, which are each I-shaped in cross section Horizontal frame portions 50, 52, of the sections 46 and 48, respectively, in FIG. 7 are provided. Each of the one piece frame sections 46, 38, has a vertical portion 54, 56 respectively, and each-also has an integral horizontal portion 50 or 52. The bottom horizontal portion 50 defines a bottom wall of the frame 12, and the horizontal portion 52 defines a top wall of the frame 12.

In FIG. 1, a handle 40 is attached to the top of the frame above the center of gravity 42 of the first section 10. In FIG. 7, each horizontal portion 50, 52 has its terminal end 62,64 connected by exterior welding 70, 72 to the vertical portions 56, 54 of the respective other one of the frame members 46 or 48.

Vertical forward and rearward planar surfaces 74 and 76 of the frame 12 are formed, FIG. 7, by the exterior of the vertical wall portions 54 and 56.

In FIG. 5A, right and left end walls 84 extend transversely to the frame 12, closing the end of the frame 12. The right and left end walls 84 of the frame 12 are identical.

The end walls 84 are each secured by welding and are at 90 degrees to the forward and rearward side walls 23 and 19. Notch liners are not shown in the notches of the spacer of FIGS. 8 and 9, because they are already illustrated in the FIGS. 5 and 6, but liners would be used in the spacer of FIG. 8 also. The frame 12 of FIG. 1 can have notch liners such as are shown in FIG. 6 and 7, in the notches 20, 80 and 82, but liner are not shown in figured.

The frame 12 can be made of a simple inverted “U” shape and be without the notch liners 100. But the more transverse connection structure there is between the forward and rearward sidewalls 19 and 23, the better.

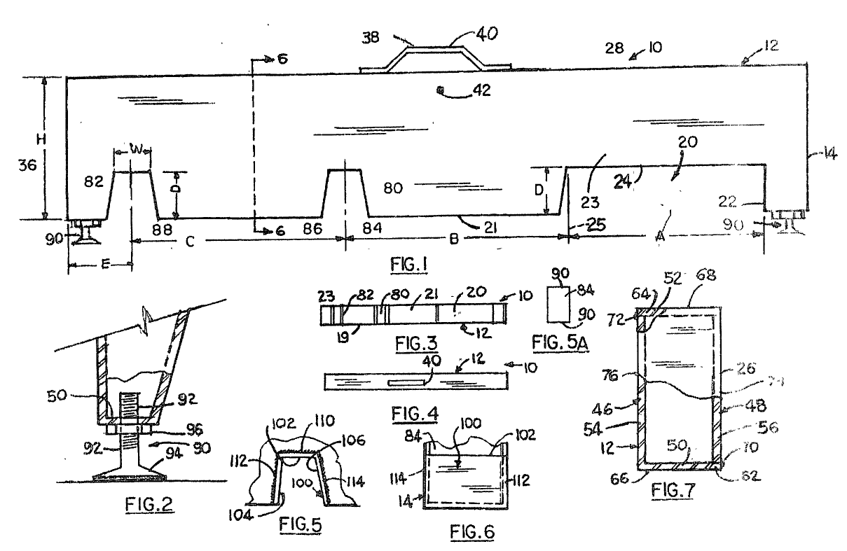

In FIGS. 1 and 2, at each end of the spacer frame 12, is one of two leg assemblies 90, each having an elongated threaded shaft 92 with a foot 94 at its lower end. In example FIG. 2 each threaded shaft 92 extends upwardly from the foot 94 through a nut or threaded member 96 welded to the bottom wall 50.

Each shaft 92 extends upwardly into the frame 12 various distances. The length of the protruding part of a respective leg is rotationally adjustable.

In FIG. 5, a sample notch liner 100 has a top wall 102, and left and right sidewalls 104 and 106, downwardly extending from the top wall 102 so that each liner is of an inverted “U” shape.

The top and side walls 102, 104 and 106 are each welded to the front and rear walls 56, and 54 of the frame 12. The weldings are at 110, 112 and 114 in FIG. 5.

The liners 100 are sized to removeably receive studs inserted into them and the notches are accordingly spaced along the spacer 10 so that when studs are inserted into the notches, the studs are appropriately spaced for the wall being built. After work on the studs is completed the studding spacer 10 may be easily removed from the studs and transported.

In FIGS. 8 and 9, a second-used second spacer 160 which has a frame of a construction identical to the first used spacer of FIGS. 1 to 7. Although the length of this spacer 160 is much longer.

The frame 162 has a handle 190 attached to its top above its center of gravity 192.

Some notch spacing in FIG. 8 are of one greater dimension as at G, J, and K, others are different small dimensions as at H, I, J, and M.

The second spacer frame 162 has notches 170, 172, 174, 178, 180, 182, and 184 which are each of a width, from right to left, to receive studding commonly called a 2 by 4, or a 2 by 6 and the notch spacings are fit for such studdings.

The studding spacers described herein are preferably composed of sheet metal. However, future developments of plastic and graphite compounds of sufficient rigidity, durability, and cost efficiency could be used.

It will be apparent that various changes may be made in the form, construction and arrangements of the components of the spacers hereof without departing from the scope and spirit of this invention and without sacrificing all of its material advantages.

The form of the spacers above are merely explanatory embodiments. It is the intention of the following claims to encompass and include many changes.

1. A stud spacer comprising:
A frame having top and bottom and forward and rearward sides and right and left ends, said frame being elongated from right to left, said frame having a row of notches spaced various distances from said right end, said notches extending upwardly from the bottom of said frame and completely through said frame from said forward to rearward sides of said frame, each of said notches being of a size for receiving an edge portion of a common wall studding when such studding is rested on a horizontal surface, said frame being substantially hollow for lightness and maneuverability.

2. The spacer of claim 1 having said frame having vertical forward and rearward walls said frame having horizontal top and bottom walls, said frame having two elongated sections each of which have a vertical straight flange and a horizontal straight flange, means connecting said sections together to form a rectangular configuration when seen in a cross-section normal to said frame.

3. The spacer of claim 2 having a pair of legs spaced along said frame, means attaching said legs to said frame in a manner permitting the bottoms of said legs to be adjusted to be at various distances from said frame.

4. The spacer of claim 3 having one of said notches being at an end of said row of notches, said one notch being larger than the others for receiving a studding group of a kind used in a corner of a building.

5. A studding spacer of claim 1 comprising: said frame having top and bottom and forward and rearward sides and right and left ends, said frame being elongated from right to left, said frame having a row of notches spaced various distances from said right end, said notches extending completely through said frame from said forward side to said rearward side, said notches sliding into said frame from its bottom side, each of said notches being of a size for receiving an edge portion of a common wall studding when such studding is rested on a horizontal surface, said frame having vertical forward and rearward walls said frame having horizontal top and bottom walls, said frame having two elongated sections each of which have a vertical straight flange and a horizontal straight flange, means connecting said sections together to form a rectangular configuration when seen in a cross-section normal to said frame.

6. The spacer of claim 5 having a handle at its top above the center of gravity.

7. The spacer of claim 1 having said notches have walls which diverge toward their lower ends so as to more easily receive studs.

8. The spacer of claim 1 having said notches have walls which diverge toward their lower ends so as to more easily receive studs.

9. The spacer of claim 2 having said notches have walls which diverge toward their lower ends so as to more easily receive studs.

10. The spacer of claim 3 having said notches have walls which diverge toward their lower ends so as to more easily receive studs.

11. The spacer of claim 4 having said notches have walls which diverge toward their lower ends so as to more easily receive studs.

12. The spacer of claim 5 having said notches have walls which diverge toward their lower ends so as to more easily receive studs.
